(19) United States
(12) Patent Application Publication
(10) Pub. No.: US 2007/0154247 A1
(43) Pub. Date: Jul. 5, 2007

(54) Position clutch device and image forming apparatus using the same

(75) Inventor: Kwoang-joe Seorl, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/493,631

(22) Filed: Jul. 27, 2006

(30) Foreign Application Priority Data
Jan. 3, 2006 (KR) 10-2006-0000591

(51) Int. Cl. G03G 21/00

(52) U.S. Cl. 399/350

(57) ABSTRACT

An improved position clutch includes a motor, a worm gear shaft, a cam gear, a cam shaft, and a cam. The worm gear shaft is rotated by the motor and has a worm gear portion on a predetermined section of the end of the shaft. The cam gear has at least one teeth portion formed on its circumference, and the cam gear engages the worm gear portion. The cam shaft is connected to the cam gear; and the cam is connected to the cam shaft. The cam engages an object, such as a cleaning blade, to control the position of the object.

### CROSS-REFERENCE TO RELATED APPLICATIONS

This application claims the benefit under 35 U.S.C. § 119(a) of Korean Patent Application No. 2006-591, filed on Jan. 3, 2006, the entire content of which is hereby incorporated by reference.

### BACKGROUND OF THE INVENTION

1. Field of the Invention

The present invention generally relates to a position clutch device and an image forming apparatus using the same. More particularly, the present invention relates to a position clutch device for controlling the position of an object using gear teeth and an image forming apparatus using the same.

2. Description of the Related Art

In general, an image forming apparatus such as a laser beam printer scans light onto a photosensitive medium charged with a predetermined potential to form an electrostatic latent image. The electrostatic latent image formed on the photosensitive medium is developed by a developing unit using developer of a certain color, transferred onto a recording medium using the medium of a transfer member such as a transfer belt, fixed by a fixing unit and discharged from the main body of the image forming apparatus.

FIG. 1 illustrates a portion of the structure of a conventional image forming apparatus. Referring to FIG. 1, the image forming apparatus 1 includes a photosensitive drum 3 having an electrostatic latent image formed on the surface thereof, developing units 5Y, 5M, 5C and 5K for developing the electrostatic latent image formed on the photosensitive drum 3 with developers of predetermined colors, a transfer belt 7 on which a visible image developed with developers by the developing units 5Y, 5M, 5C and 5K is intermediately transferred, and a transfer roller 9 for transferring the image from the transfer belt 7 to a recording medium P1. When color images are formed sequentially on the photosensitive medium 3 through the developing units 5Y, 5M, 5C and 5K of each color, the color images are transferred and superimposed sequentially onto the transfer belt 7. The superimposed color image is then transferred onto the recording medium P1 that passes between the transfer belt 7 and the transfer roller 9 by the transfer roller 9 rotating in contact with the transfer belt 7.

Meanwhile, residual developer on the transfer belt 7 after the color image is transferred onto the recording medium P1 from the transfer belt 7 is removed by a cleaning unit 13.

FIG. 2 is an enlarged view of a portion indicated by II in FIG. 1.

Referring to FIG. 2, when a color image is being formed by superimposition on the transfer belt 7 the transfer roller 9 is disengaged (indicated by the dotted lines) from the transfer belt 7, and after the color image is completely formed the transfer roller 9 is engaged again with the transfer belt 7. In other words, a cam 11 is rotated to the position indicated by solid lines and the transfer roller 9 is pressed toward the transfer belt 7, thereby making the transfer roller 9 engage the transfer belt 7. In this manner, the color image that has been transferred and superimposed on the transfer belt 7 is transferred onto the recording medium P1. Meanwhile, if the cam 11 is rotated to the position shown with the dotted lines, the transfer roller 9 is disengaged from the transfer belt 7 and images of each color are sequentially transferred onto the transfer belt 7, making a full color image.

The cam 11 enables the transfer roller 9 to engage (indicated by the solid lines) or disengage the transfer belt 7. The cam 11 is driven by a cam driving unit 30 (to be described with reference to FIGS. 4 and 5).

FIG. 3 is an enlarged view of the area indicated by III in FIG. 1.

Referring to FIG. 3, the cleaning unit 13 is formed by a cleaning blade 13a and a waste developer container 13b. One end of the cleaning blade 13 is rotatably supported to engage or disengage the transfer belt 7. The waste developer container 13b stores waste developer removed by the cleaning blade 13a.

The cleaning blade 13a contacts the transfer belt 7 during the cleaning operation, and removes waste developer remaining on the surface of the transfer belt 7. Meanwhile, when the cleaning blade 13a is not cleaning, it is disengaged from the transfer belt 7 and an image is transferred onto the transfer belt 7. That is, when the cam 11′ rotates to the position indicated by the dotted lines, it engages the cleaning blade 13a with the transfer belt 7 to make it perform the cleaning operation. On the other hand, when the cam 11′ rotates to the position indicated by the solid lines, the cleaning blade 13a is disengaged from the transfer belt 7, and the transfer belt 7 performs the transferring operation.

Therefore, the cam 11′ allows the cleaning blade 13a to engage or disengage the transfer belt 7. The cam 11′ is driven by a cam driving unit 30, which will now be explained in detail.

FIG. 4 is a perspective view of an example of a cam driving unit for driving the cam in FIGS. 2 and 3, and FIG. 5 is an exploded perspective view of a spring clutch.

Referring to FIG. 4, a cam shaft 31 having one end connected to the cam 11 and 11′ is connected to a cam gear 50 through a spring clutch assembly 40. The cam gear 50 is connected to a motor by a gear train (not shown). The cam driving unit further includes a solenoid 70 for selectively providing loads on the spring clutch assembly 40 and controlling the position of the rotation.

A plurality of inclined projections 41a are formed at regular intervals on the external surface of a cylindrical body 41 constituting the spring clutch assembly 40. In addition, a locking member 80 is formed as a projection 81 that is caught in the inclined projections 41a. The locking member 80 is hinged to a solenoid bracket 91.

The solenoid 70 is fixed to the solenoid bracket 91, and has a metallic or magnetic plunger (not shown) pivotably connected to the locking member 80 to be able to move the locking member 80 to a locking position and a releasing position. The plunger is pressed by a compression spring (not shown) to press the locking member 80 toward the locking position.

Referring to FIG. 5, the spring clutch assembly 40 includes a first hub 51 formed at one side of the cam gear 50.

The cylindrical body 41 is rotatably fit into the circumferential surface of the first hub 51, and a clutch spring 43 is disposed between the first hub 51 and the cylindrical body 41 so that it slidably engages the first hub 51.

A first end portion 43a of the clutch spring 43 is fixed into a spring fixing groove 41b of the cylindrical body 43, and a second end portion 43b is fixed into a spring fixing groove 45a′ formed in the flange 45a of a second hub 45.

The second hub 45 is connected with the cam shaft 31 through a fixing hole 45b of the flange 45a, and the clutch spring 43 is wound around its circumferential surface.

To explain the principle of operation of the above-described cam driving unit, the cam gear 50 is driven by a motor (not shown) so that it continuously rotates.

When the solenoid 70 is turned on while the cam gear is rotated, the plunger moves the locking member 80 to the releasing position where the projection 81 is pulled up by a magnetic force generated by the internal coils of the solenoid 71 and is released from the inclined projection 41a.

When the locking member 80 moves to the releasing position, the cylindrical body 41 of the clutch spring 43 is rotated in the rotational direction of the cam gear 50, i.e., in the direction of the arrow A, by friction between the first hub 51 and the clutch spring 43. As the cylindrical body 41 rotates, the clutch spring 43 fixed in the spring fixing groove 45a′ of the flange 45a winds around and adheres to the circumferential surfaces of the first and second hubs 51 and 45. Accordingly, the rotational force of the cam gear 50 is transferred to the cam shaft 31 through the first and second hubs 51 and 45 and the clutch spring 43, and the cam shaft 31 is rotated in the direction of the arrow A.

The above-described conventional cam driving unit has an issue in that its operating reliability is easily influenced by changes in the size or condition of the surface of the clutch spring 43.

In addition, its structure is complex, which increases material cost.

Moreover, since the power is controlled by the clutch spring 43, the clutch spring 43 limits the transfer load.

Accordingly, there is a need for an improved clutching apparatus for an image forming apparatus.

### SUMMARY OF THE INVENTION

An aspect of the present invention is to address at least the above problems and/or disadvantages and to provide at least the advantages described below. Accordingly, an aspect of the present invention is to provide a position clutch device capable of rotating a cam to a specific position without requiring a separate interrupt generation unit.

Another object of the present invention is to provide an image forming apparatus characterized of a simplified interrupt generation structure for a cleaning blade through the above-described position clutch.

Still another object of the present invention is to provide an image forming apparatus characterized of a simplified interrupt generation structure for a transfer roller through the above-described position clutch.

In accordance with an aspect of the present invention, a position clutch device includes a motor and a worm gear shaft rotated by the motor. The worm gear shaft has a worm gear portion formed on a first end of the worm gear shaft, and a cam gear has at least one teeth portion that engages the worm gear portion. A cam shaft is connected to the cam gear, and at least one cam is connected to the cam shaft. The at least one cam engages an object to control the position of the object.

The device may further include an elastic unit for preventing the teeth portion of the cam gear from disengaging the worm gear portion.

The elastic unit may comprise a torsion spring, a first end of which is fixed onto the cam gear shaft, and a second end of which is combined with a fixing body.

The motor may be rotated in clockwise and counterclockwise directions.

The device may further include a follower gear formed on a second end of the worm gear shaft, and a driving gear disposed on a shaft of the motor, the driving gear engaging the follower gear.

In accordance with another aspect of the present invention, an image forming apparatus includes at least one photosensitive medium for forming an electrostatic latent image and at least one developer for developing the electrostatic latent image on the photosensitive medium with developer. A transfer unit transfers the developed image onto a recording medium, and a cleaning blade removes waste developer remaining on the photosensitive medium. A cleaning blade interrupt generation unit engages or disengages the cleaning blade with the photosensitive medium. The cleaning blade interrupt generation unit includes a motor and a worm gear shaft rotated by the motor. The worm gear shaft has a worm gear portion formed on a first end of the worm gear shaft, and a cam gear has at least one teeth portion that engages the worm gear portion. A cam shaft is connected to the cam gear, and at least one cam is connected to the cam shaft. The at least one cam engages the cleaning blade to control the position of the cleaning blade.

The image forming apparatus may further include an elastic unit for preventing the teeth portion of the cam gear from disengaging the worm gear portion.

The elastic unit may comprise a torsion spring, a first end of which is fixed onto the cam gear shaft, and a second end of which is combined with a fixing body.

The motor may be rotated in clockwise and counterclockwise directions.

The image forming apparatus may further include a follower gear formed on a second end of the worm gear shaft, and a driving gear disposed on a shaft of the motor, the driving gear engaging the follower gear.

In accordance with still another aspect of the present invention, an image forming apparatus has at least one photosensitive medium for forming electrostatic latent images and at least one developer for developing the electrostatic latent images formed on the photosensitive medium with a color developer. The developed images are transferred and superimposed upon each other on a transfer belt. A transfer roller transfers the superimposed color image formed on the transfer belt onto a recording medium, and a transfer roller interrupt generation unit engages or disengages the transfer roller with the transfer belt. The transfer roller interrupt generation unit has a motor and a worm gear shaft rotated by the motor. The worm gear shaft has a worm gear portion formed on a first end of the worm gear shaft, and a cam gear has at least one teeth portion that engages the worm gear portion. A cam shaft is connected to the cam gear, and at least one cam is connected to the cam shaft. The at least one cam engages the transfer roller to control the position of the transfer roller.

The image forming apparatus may further include an elastic unit for preventing the teeth portion of the cam gear from disengaging the worm gear portion.

The elastic unit may comprise a torsion spring, a first end of which is fixed onto the cam gear shaft, and a second end of which is combined with a fixing body.

The motor may be rotated in clockwise and counterclockwise directions.

The image forming apparatus may further include a follower gear formed on a second end of the worm gear shaft, and a driving gear disposed on a shaft of the motor, the driving gear engaging the follower gear.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a side view of a portion of the structure of a conventional image forming apparatus;

FIG. 2 is an enlarged view of the area indicated by II in FIG. 1;

FIG. 3 is an enlarged view of the area indicated by III in FIG. 1;

FIG. 4 is a perspective view of an exemplary embodiment of a cam driving unit for driving the cam in FIGS. 2 and 3;

FIG. 5 is an exploded perspective view of the structure of the spring clutch in FIG. 4;

FIG. 6 is a schematic diagram of an image forming apparatus with a position clutch according to an exemplary embodiment of the present invention is applied;

FIG. 7 is an enlarged view of the area indicated by VII in FIG. 6;

FIG. 8 is an enlarged view of the area indicated by VIII in FIG. 6;

FIG. 9 is an enlarged view of the area indicated by IX in FIG. 6;

FIG. 10 is a perspective view of a transfer belt interrupter unit and a first and a second cleaning blade interrupter unit for use in the exemplary embodiments of the present invention;

FIG. 11 is a diagram of a state in which the second cleaning blade of the exemplary embodiment of the present invention is engaged with the transfer belt; and

FIG. 12 is a diagram of a state in which the second cleaning blade of the exemplary embodiment of the present invention is disengaged from the transfer belt.

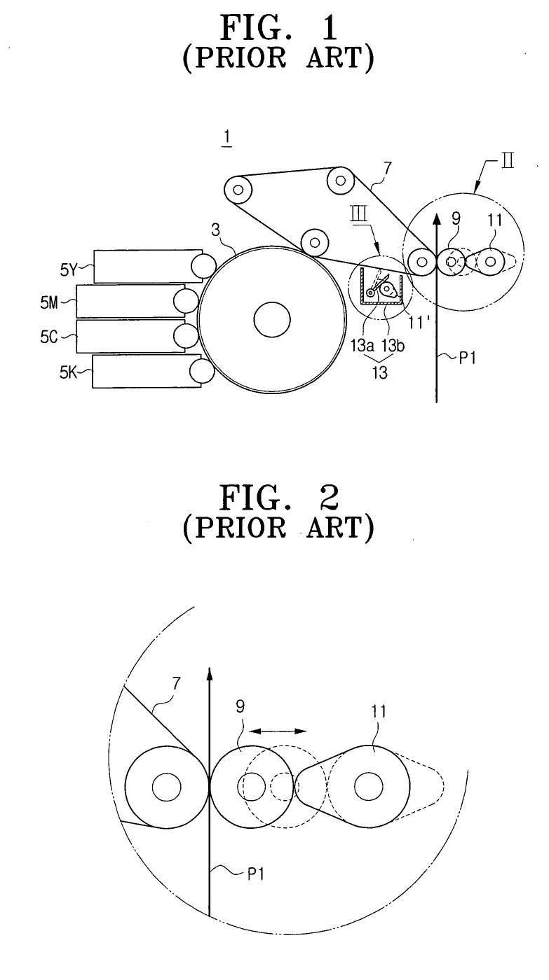

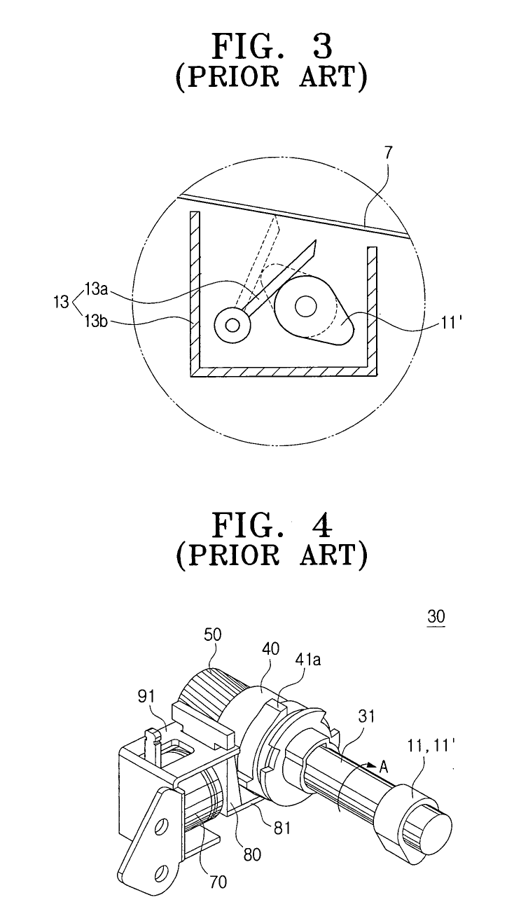

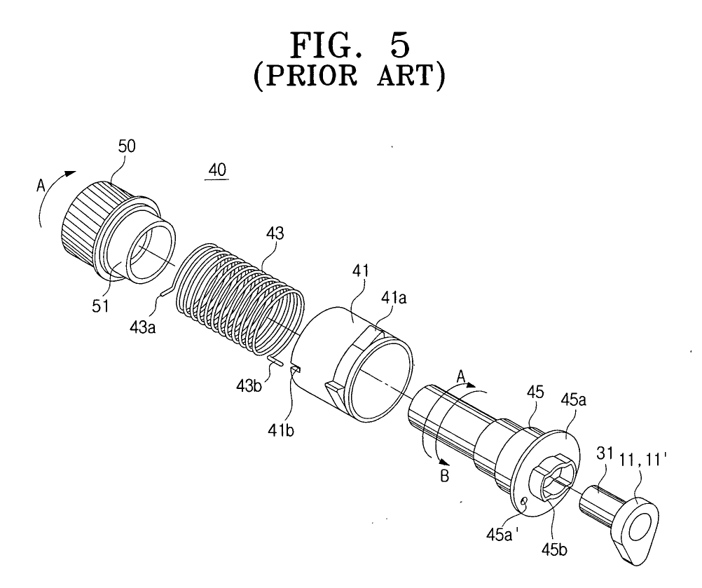

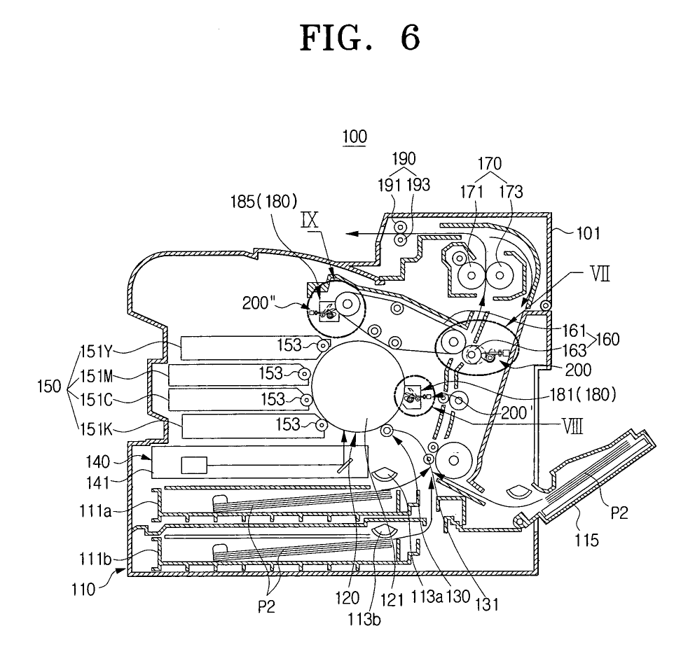

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

FIG. 6 is a schematic diagram of an image forming apparatus with a position clutch according to an exemplary embodiment of the present invention. Referring to FIG. 6, a color image forming apparatus 100 includes a main body 101, a recording medium supply unit 110, a photosensitive unit 120, a charging unit 130, an exposure unit 140, a developing unit 150, a transfer unit 160, a fixing unit 170, a cleaning unit 180, and a (paper) delivery unit 190.

The recording medium supply unit 110 includes recording medium cassettes 111a and 111b for loading or stacking plural sheets of recording medium, and pick-up rollers 113a and 113b for picking up the recording medium stacked on the recording medium cassettes 111a and 111b. Optionally, the recording medium supply unit 110 may further include an MPF (multi-purpose feeder) 115.

The photosensitive unit 120 forms an electrostatic latent image on its surface. Generally, it is formed of a photosensitive drum 121 that is produced by coating the circumference of a cylindrical-shaped metallic drum with a photoconductive layer.

The charging unit 130 charges the photosensitive drum 121 with a uniform potential, and includes a charging roller 131 supplying an electric charge to the circumferential surface of the photosensitive drum 121. The charging roller 131 may contact the photosensitive drum 121 or may be spaced apart from the photosensitive drum 121.

The exposure unit 140 scans light corresponding to image information onto the photosensitive drum 121, which has been charged with the uniform potential through the charging roller 131, and forms an electrostatic latent image. In general, the exposure unit 140 is a laser scanning unit 141 using a laser diode as a light source.

The developing unit 150 includes four developer units 151Y, 151M, 151C and 151K, which accommodate developers of four colors, for example, yellow, magenta, cyan and black, respectively. Each of the developer units includes a developing roller 153 for forming a developed image by applying developer to the electrostatic latent image formed on the photosensitive drum 121.

The transfer unit 160 includes a transfer belt 161 on which Y, M, C and B color images on the photosensitive drum 121 are sequentially transferred and superimposed with each other to form a full color image, and a transfer roller 163 for transferring the superimposed color image from the transfer belt 161 onto a recording medium P2. In detail, when a color image is being transferred onto the transfer belt 161, the transfer roller 163 is disengaged from the transfer belt 161. After the color image is completely transferred onto the transfer belt 161, the transfer roller 163 engages the transfer belt 161 with a predetermined pressure to transfer the color image onto the recording medium P2. A transfer roller interrupt generation unit 200 (to be described later) allows the transfer roller 163 engage/disengage with/from the transfer belt 161.

The fixing unit 170 thermally compresses the image that has been transferred onto the recording medium P2 through the transfer unit 160, and includes a heating roller 171 and a pressing roller 173.

The cleaning unit 180 includes a first cleaning unit 181 for removing waste developer remaining on the photosensitive drum 121 after the developed image is transferred onto the transfer belt 163, and a second cleaning unit 185 for removing waste developer remaining on the transfer belt 161 after the color image is transferred onto the recording medium P2.

The delivery unit 190 discharges the recording medium P2 bearing the color image fixed by the fixing unit 170 outside the main body 101, and includes a supply roller 191 and an idle roller 193.

The operation of the above-described structure will now be described.

Color image information is a mixture of information corresponding to Y, M, C and B colors. In this exemplary embodiment, it is assumed that Y, M, C and B developers are sequentially superimposed on the transfer belt 161 and then the superimposed image is transferred onto the recording medium P2.

At first, the circumferential surface of the photosensitive drum 121 is charged with a uniform potential by the charging roller 131. When an optical signal corresponding to the yellow image information is scanned on the photosensitive drum 121 by the exposure unit 140, an electrostatic latent image is formed on the circumferential surface of the photosensitive drum 121.

As the photosensitive drum 121 rotates and the electrostatic latent image approaches the yellow developer 151Y, the developing roller 153 of the yellow developer 151Y rotates to develop the electrostatic latent image formed on the circumferential surface of the photosensitive drum 121 into a developed yellow color image.

Next, the developed yellow color image on the circumferential surface of the photosensitive drum 121 is transferred onto the transfer belt 161 which travels in an endless loop in contact with the circumference of the photosensitive drum 121.

After the developed yellow color image is completely transferred onto the transfer belt 161, magenta, cyan and black color images also go through the same procedure, that is, they are transferred and superimposed with each other onto the transfer belt 161 to make a full color image.

Throughout the above-described procedure, the transfer roller 163 remains disengaged from the transfer belt 161. However, when the four-color developed images are all transferred and superimposed onto the transfer belt 161 and form a color image, the transfer roller 163 engages the transfer belt 161 to transfer the resulting color image onto the recording medium P2.

In the meantime, the recording medium P2 is fed from the paper feeding cassettes 111a and 111b or the MPF 115 to the point where the transfer belt 161 engages the transfer roller 163. When the recording medium P2 passes between the transfer belt 161 and the transfer roller 163, the color image is transferred onto the recording medium P2.

Later, the recording medium P2 bearing the color image passes through the fixing unit 170. Then, the color image on the recording medium P2 is fixed onto the recording medium P2 by heat and pressure provided by the fixing unit 170. The recording medium P2 having the color image fixed thereon is discharged outside the main body 101 by the delivery unit 190.

Meanwhile, the first and second cleaning units 181 and 185 remove developer remaining on the photosensitive drum 121 and transfer belt 161 for subsequent printing.

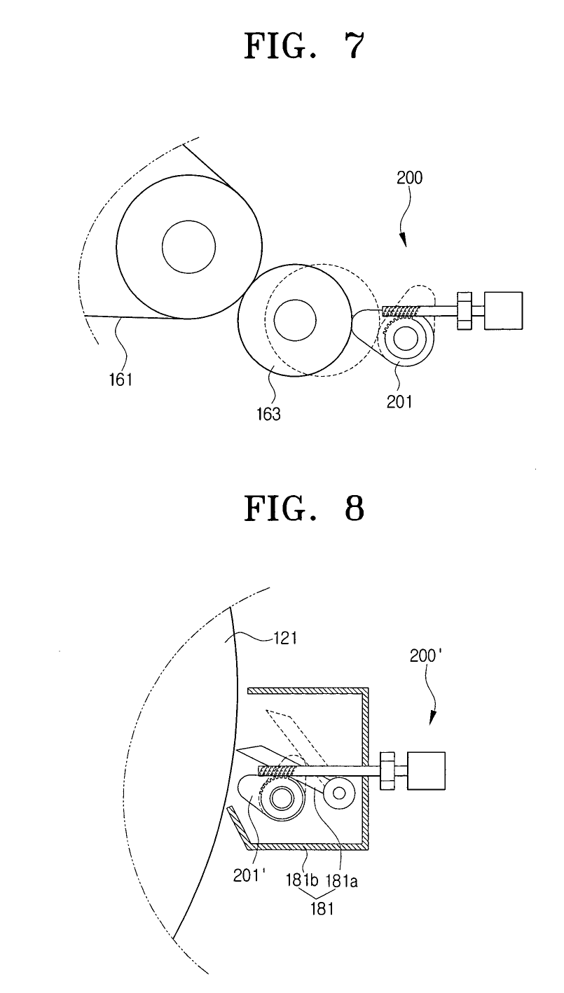

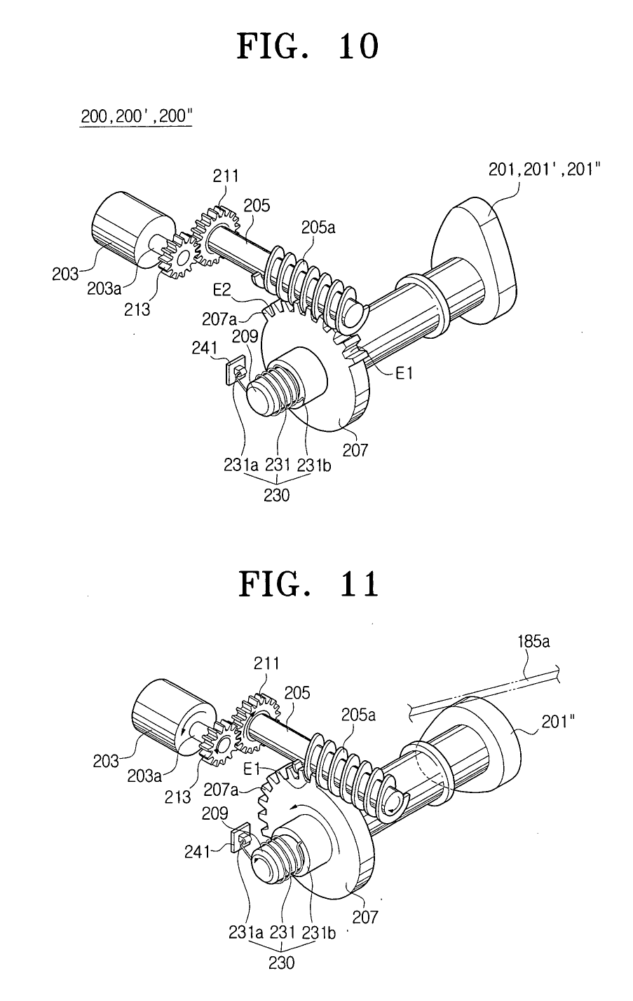

FIG. 7 is an enlarged view of the area indicated by VII in FIG. 6. Referring to FIG. 7, the transfer roller 163 engages the transfer belt 163 or is disengaged from the transfer belt 163 according to the rotation of the cam 201, which forms the transfer roller interrupt generation unit 200. The structure of the cam 201 will be described later with reference to FIG. 10.

FIG. 8 is enlarged view of the portion indicated by VIII in FIG. 6. Referring to FIG. 8, the first cleaning unit 181 includes a first cleaning blade 181a and a waste developer container 181b. One end of the first cleaning blade 181a is rotatably supported, and the waste developer container 181b collects waste developer removed by the first cleaning blade 181a. The first cleaning blade 181a engages the photosensitive drum 121 during cleaning, and is disengaged from the photosensitive drum 121 when cleaning is not being performed. The first cleaning blade 181a is either engaged with or disengaged from the photosensitive drum 121 according to the rotation of the cam 201′, which forms the first cleaning blade interrupt generation unit 200′.

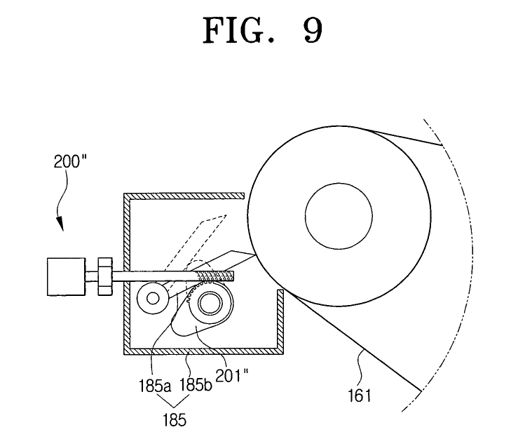

FIG. 9 is an enlarged view of the portion indicated by IX in FIG. 6. Referring to FIG. 9, similar to the first cleaning unit 181 in FIG. 8, the second cleaning unit 185 includes a second cleaning blade 185a and a second waste developer container 185b. The second cleaning blade 185 is also engaged with or disengaged from the transfer belt 161 depending on the rotation of the cam 201″, which forms the second cleaning blade interrupt generation unit 200″.

The transfer belt interrupt generation unit 200 and the first and second cleaning blade interrupt generation units 200′ and 200″ will now be described in further detail.

FIG. 10 is a perspective view illustrating the transfer belt interrupt generation unit 200 and the first and second cleaning blade interrupt generation units 200′ and 200″ used in the exemplary embodiment of the present invention.

Since the cam 201 of the transfer belt interrupt generation unit 200 and the cams 201′ and 201″ of the first and second cleaning blade interrupt generation units 200, 200′ and 200″ are formed by the same elements, like reference numerals are used for like elements and their construction will be described collectively.

As shown in FIG. 10, the transfer belt interrupt generation unit 200 and the first and second cleaning blade interrupt generation units 200′ and 200″ respectively include a motor 203, and a worm gear shaft 205 which is driven by the motor 203. A worm gear portion 205a on a predetermined section of a first end portion of the worm gear shaft 205. A cam gear 207 has a teeth portion 207a formed on a part of its circumferential surface which engages the worm gear portion 205a, and a cam shaft 209 which is connected to the cam gear 207. Here, the cam shaft 209 is connected to the cams 201, 201′, and 201″ that are engaged with objects for position control, that is, the transfer roller 163 and the first and second cleaning blades 181b and 183b.

Additionally, a follower roller 211 may be formed at a second end of the worm gear shaft 205, and a driving roller 213 that engages the follower roller 211 may be formed on the shaft 203a of the motor 203.

An elastic unit 230 prevents disengagement of the end portion E1 or E2 of the teeth portion 207a of the cam gear 207 from the worm gear portion 205a of the worm gear shaft 205 when the cam gear 207 rotates in the clockwise direction or counterclockwise direction may be provided. The elastic unit 230 may be a torsion spring 231. If so, a first end portion 231a of the torsion spring 231 is connected to a fixing body 241, and a second end portion 231 of the torsion spring 230 is connected to the cam gear shaft 209 or the cam gear 207. FIG. 10 illustrates a case where the second end portion 231b of the torsion spring 230 is connected to the cam gear 207. The teeth portion 207a of the cam gear 207 may have a constant elastic force to maintain the state shown in FIG. 10 all the time. In this manner, when the end portions E1 or E2 of the teeth portion 207a of the cam gear 207 return from their movement, the cam gear portion 207a and the worm gear portion 205a are not separated but remained engaged with the worm gear 105. The fixing body 241 may be the main body of the image forming apparatus, for example.

The operation of the second cleaning blade interrupt generation unit having the above-described construction will now be described.

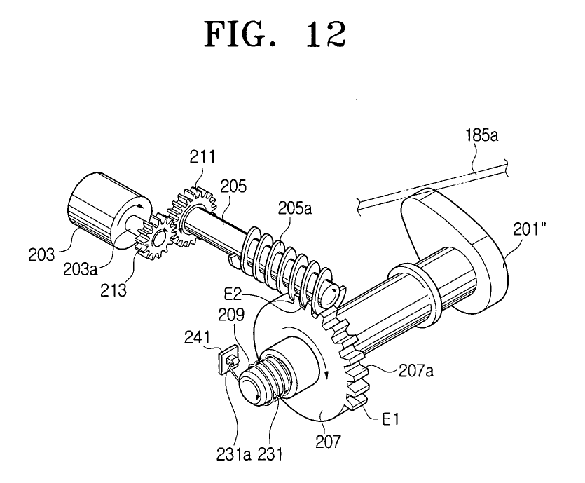

FIG. 11 is a diagram showing a state in which the second cleaning blade of the exemplary embodiment of the present invention is engaged with a transfer belt, and FIG. 12 is a diagram showing a state in which the exemplary embodiment of the second cleaning blade of the present invention is disengaged from a transfer belt.

Referring to FIGS. 9 and 11, during the cleaning operation for removing waste developer remaining on the transfer belt 161, the motor in the state of FIG. 10 is driven in the counterclockwise direction, which in turn drives the driving gear 213 in the counterclockwise direction also. Then, the follower gear 211 and the worm gear shaft 205 connected to the follower gear rotate in the clockwise direction. As a result, the cam gear 207 which engages the worm gear portion 205a by means of the teeth portion 207a is rotated in the counterclockwise direction, causing the cam 201′ to rotate.

The above-described operation continues until one end portion E1 of the teeth portion 207a reaches the end of the worm gear portion 205a. When this occurs, the cam gear 207 and the cam shaft 208 stop rotating.

Therefore, the cam 201″ moves into the state depicted in solid lines in FIG. 9, and the second cleaning blade 185a engages the transfer belt 161 and removes the waste developer remaining thereon.

At this time, the torsion spring 231 elastically presses the cam gear 207 in the clockwise direction. Consequently, the end portion E1 of the cam gear 207 is not disengaged from the end of the worm gear portion 205a, but remained engaged with the worm gear portion 205a instead.

On the other hand, referring to FIGS. 9 and 12, when transferring and superimposing a color image onto the transfer belt 161, the motor 203 in the state shown in FIG. 11 is driven in the clockwise direction, which in turn drives the driving gear 213 in the clockwise direction also. Then, the follower gear 211 and the worm gear shaft 205 connected to the follower gear 211 rotate in the counterclockwise direction. As a result, the cam gear 207 which engages the worm gear portion 205a by means of the teeth portion 207a is rotated in the clockwise direction, causing the cam 201″ to rotate.

The above-described operation continues until the end portion E1 of the teeth portion 207a reaches the other end of the worm gear portion 205a. When this occurs, the cam gear 207 and the cam shaft 208 stop rotating.

Consequently, the cam 201″ moves into the state depicted in dotted lines in FIG. 9, and the second cleaning blade 185b is disengaged from the transfer belt 161, allowing a predetermined color image to be formed on the transfer belt 161.

The torsion spring 231 elastically presses the cam gear 207 in the counterclockwise direction. Consequently, the end portion E2 of the cam gear 207 is not disengaged from the end of the worm gear portion 205a, but remains engaged with the worm gear portion 205a instead.

The above-described operation is equally applicable to the transfer roller interrupt generation unit 200 and the first cleaning blade interrupt generation unit 200′, so a detailed description of the operation of those structures will not be repeated.

Although the above-described description is focused on the structure for moving the first and second cleaning blades 181a and 181b and the transfer roller 163, it can also be applied to every structure that moves linearly by the rotation of the cam. For instance, the same operational principle can be applied to a structure for selectively engaging/disengaging the developer units 151Y, 151M, 151C and 151K of every color with/from the photosensitive drum 121 using the cam. Since the phase of the cam should be limited to four, a plurality of worm gear shafts 205 and their corresponding teeth portions 207a of the cam gear 207 are used.

As explained so far, the position clutch device of the present invention is advantageous in that it simplifies the overall structure of the image forming apparatus and reduces material cost.

In addition, the reliability of the cam driving is improved since the conventional spring clutch, which may introduce reliability issues, is no longer required.

Moreover, the limit of transfer loads is increased since the spring clutch with a limited ability to transfer loads is no longer used.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A position clutch device, comprising:
a motor;
a worm gear shaft rotated by the motor, the worm gear shaft comprising a worm gear portion formed on a first end of the worm gear shaft;
a cam gear comprising at least one teeth portion that engages the worm gear portion;
a cam shaft connected to the cam gear; and
at least one cam connected to the cam shaft, the at least one cam engaging an object to control the position of the object.

2. The device of claim 1, further comprising:
an elastic unit for preventing the teeth portion of the cam gear from disengaging the worm gear portion.

3. The device of claim 2, wherein the elastic unit comprises a torsion spring, a first end of which is fixed onto the cam gear shaft, and a second end of which is combined with a fixing body.

4. The device of claim 1, wherein the motor is rotated in clockwise and counterclockwise directions.

5. The device of claim 1, further comprising:
a follower gear formed on a second end of the worm gear shaft; and
a driving gear disposed on a shaft of the motor, the driving gear engaging the follower gear.

6. An image forming apparatus, comprising:
at least one photosensitive medium for forming an electrostatic latent image;
at least one developer for developing the electrostatic latent image on the photosensitive medium with developer;
a transfer unit for transferring the developed image onto a recording medium;
a cleaning blade for removing waste developer remaining on the photosensitive medium; and
a cleaning blade interrupt generation unit for engaging/disengaging the cleaning blade with/from the photosensitive medium, the cleaning blade interrupt generation unit comprising:
a motor;
a worm gear shaft rotated by the motor, the worm gear shaft comprising a worm gear portion formed on a first end of the worm gear shaft;
a cam gear comprising at least one teeth portion that engages the worm gear portion;
a cam shaft connected to the cam gear; and
at least one cam connected to the cam shaft, the at least one cam controlling the position of the cleaning blade.

7. The apparatus of claim 6, further comprising:
an elastic unit for preventing the teeth portion of the cam gear from disengaging the worm gear portion.

8. The apparatus of claim 7, wherein the elastic unit comprises a torsion spring, a first end of which is fixed onto the cam gear shaft, and a second end of which is combined with a fixing body.

9. The apparatus of claim 6, wherein the motor is rotated in clockwise and counterclockwise directions.

10. The apparatus of claim 6, further comprising:
a follower gear formed on a second end of the worm gear shaft; and
a driving gear disposed on a shaft of the motor, the driving gear engaging the follower gear.

11. An image forming apparatus, comprising:
at least one photosensitive medium for forming electrostatic latent images;
at least one developer for developing the electrostatic latent images formed on the photosensitive medium with a color developer;
a transfer belt on which the developed images are transferred and superimposed upon each other;
a transfer roller for transferring the superimposed color image formed on the transfer belt onto a recording medium; and
a transfer roller interrupt generation unit for engaging/disengaging the transfer roller with/from the transfer belt, the transfer roller interrupt generation unit comprising:
a motor;
a worm gear shaft rotated by the motor, the worm gear shaft comprising a worm gear portion formed on a first end of the worm gear shaft;
a cam gear comprising at least one teeth portion that engages the worm gear portion;
a cam shaft connected to the cam gear; and
at least one cam connected to the cam shaft, the at least one cam controlling the position of the transfer roller.

12. The apparatus of claim 9, further comprising:
an elastic unit for preventing the teeth portion of the cam gear from disengaging the worm gear portion.

13. The apparatus of claim 12, wherein the elastic unit comprises a torsion spring, a first end of which is fixed onto the cam gear shaft, and a second end of which is combined with a fixing body.

14. The apparatus of claim 11, wherein the motor is rotated in clockwise and counterclockwise directions.

15. The apparatus of claim 11, further comprising:
a follower gear formed on a second end of the worm gear shaft; and
a driving gear disposed on a shaft of the motor, the driving gear engaging the follower gear.
